(19) United States
(12) Patent Application Publication
(10) Pub. No.: US 2015/0081742 A1
(43) Pub. Date: Mar. 19, 2015

(54) HUMAN ENUMERATION AND TRACKING

(71) Applicant: Curtis Roys, Kingsland, TX (US)

(72) Inventor: Curtis Roys, Kingsland, TX (US)

(21) Appl. No.: 14/321,522

(22) Filed: Jul. 1, 2014

Related U.S. Application Data
(60) Provisional application No. 61/841,775, filed on Jul. 1, 2013.

(51) Int. Cl. G06F 17/30

(52) U.S. Cl. CPC G06F 17/30244
USPC 707/802

(57) ABSTRACT

A method and apparatus for tracking and enumerating individuals is disclosed. A machine-readable tag is issued to a responsible individual, such as a law enforcement officer, parole officer, or soldier, depending on the specific application of the invention. The information in this tag is then uploaded to a database. When appropriate, the tag is attached to an individual by the person and then scanned by a device having geographic information, such as from GPS. An image of the individual along with the tagging location and possibly other information on the individual's identity and physical condition (deceased or extent of injuries) is uploaded, such as through a cell phone communications system, a satellite communication system, or other communications system, into a database. The database can be queried by family members and loved ones, as well as other authorities.

This application claims priority from U.S. Prov. Pat. App. No. 61/841,775, filed Jul. 1, 2013, which is hereby incorporated by reference.

### TECHNICAL FIELD OF THE INVENTION

The present invention relates to management and reporting of prisoners of war, soldiers, criminal prisoners, and parolees.

### BACKGROUND OF THE INVENTION

The criminal justice system faces a difficult challenge in monitoring the locations and status of large numbers of individual, such as detainees, prisoners and parolees. Similarly, the military faces similar challenges in recording the locations and status of prisoners of war (POWs) and soldiers within a combat zone.

Physical environments such as prisons, disorderly crowds, combat zones, and POW situations present little opportunity for time-intensive reporting of locations and physical conditions of individuals, whether they are prisoners under confinement, including those temporarily detained or arrested, parolees required to periodically report to monitoring officers, or POWs and soldiers within a combat zone. Often, information about these individuals may be desired by family members or loved ones, and also by governmental officials responsible for monitoring parolees, or POWs under confinement and interrogation.

An improved, faster, less-laborious and safer method for obtaining, storing and disseminating location and status information on individuals within these stressful environments and situations could be a big benefit to many persons with a legitimate interest in this information.

### SUMMARY OF THE INVENTION

An object of the invention is to provide a method of accounting for the locations and physical status of people, for example, people within the criminal justice system (arrested persons, prisoners, and parolees), and POWs and soldiers within a combat zone.

In accordance with embodiments of the invention, a tag having machine readable information is issued to a system user, who attaches the tag to a tagged individual. The tag is scanned and information on the tag, along with information from the scanning device, such as location, information entered by the users, and any photographs of the tagged individual taken using the device, are uploaded to a database to track the tagged individual. Users can include, for example, police officers, soldiers, prison officials, and parole officers. Tagged individuals can include, for example, people detained by the police, POWs, injured soldiers, prisoners, and parolees.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a flowchart of a method for tagging individuals and then subsequently conveying this information to a database.

FIG. 2 shows the components of a Human Enumeration And Tracking (HEAT) system connected through a network.

FIG. 3 shows a flowchart of a method for retrieving information from individuals who were tagged according to the method of FIG. 1.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

Federal, state, and local law enforcement officers could use embodiments of the invention to monitor the locations and status of prisoners within various jails and prisons. The military could use embodiments of the invention within a combat zone for several important functions:

A. Recording and storing the initial location and physical status of a captured enemy combatant (a prisoner of war (POW)) within a combat zone.

B. Tracking the locations and physical status of POWs as they are subsequently transported to various confinement and interrogation facilities.

C. Tracking the locations and physical status of soldiers within a combat zone, including physical status and mental status, as well as geographical location (from GPS).

In other countries, similar agencies at various levels could use the invention for these same purposes.

This location and status information can be stored in a database and then made available selectively to those with the need or desire to know. Clearly some information should only be available to the proper authorities, such as the locations and status of POWs. The GPS locations of soldiers in combat zones also cannot be made available even to families and loved ones for security reasons. Other information, such as physical and mental health status could be made more widely available, again with restrictions to address both security and privacy concerns.

For each of these applications of the invention, the procedures may differ somewhat. For example, the invention could be used to track the location and status of individuals who have come under the jurisdiction of the justice system following an arrest (hereinafter referred to as “arrestees”, independent of any subsequent conviction or acquittal). For example, in accordance with a preferred embodiment, a police officer, at the beginning of a watch, is issued a number of tags, each including machine-readable coded information identifying the law officer (name, badge number, etc.) to whom the tag is issued. Prior to going on patrol, this identifying information is uploaded to a database. If the officer subsequently detains a suspect in a crime during, a tag is attached to the arrestee. The tag is then scanned by a device having geographic information, such as from the global positioning system (GPS). An image of the arrestee, along with the arrest location information and other information (such as alive or dead, locations on the body and severity of injuries) is uploaded, such as through a cell phone communications system, a satellite communication system, secure wireless internet, or other communications system, into a database. Whenever the arrestee changes location within the justice system, e.g., from lock-up to a court appearance, or from jail to prison, the tag is rescanned and another photograph taken, with this information uploaded to the database. Facial recognition software, retina scans, fingerprint scans, or other secondary identification means could be used to verify that the bar coded tag is still on the arm (leg, etc.) of the original arrestee.

Within the corrections system, the invention could serve to simplify and improve the efficiency of parolee-monitoring activities. Nearly all convicted individuals leave prison as “parolees” with an extended obligation to report into their parole officers, whose function is to monitor the progress of the paroled individual in re-integrating into society. Typically, a parolee is required to report in to their parole officer on a regular basis, such as every 30, 60, or 90 days. In a preferred embodiment of the invention, the parolee could go to the federal, state or local governmental facility where they are required to report and have their photo taken and the bar code scanned. This photographic information, along with the GPS location, would then be uploaded to the database and facial recognition software or other secondary identification means used to verify that the bar coded tag is still on the arm (leg, etc.) of the parolee corresponding to the scanned-in bar coded tag.

In a military context, for monitoring of POWs, application of a preferred embodiment of the invention could largely resemble the procedure outlined above for the criminal justice system. An added benefit here is the increased accountability of the military for the treatment of POWs, and also the protection which the invention will afford military personnel who might otherwise be falsely charged with prisoner abuse. Periodically-taken photographs of the POW, coupled with GPS locational data and health status information, will provide a “paper trail” to document and verify proper treatment of POWs during their detention in the course of military conflicts. Recent charges of prisoner abuse within the Guantanamo Bay facility serve as one example of a potential application of the invention.

A fourth potential application of the invention, also in a military context, is the monitoring of the locations and status of combat zone soldiers. Here, operating procedures may resemble the application of the invention to parolees described above. Already, active-duty military personnel are required to wear metal “dog tags” at all times, giving the name, serial number (same as social security number), blood-type, religious affiliation, etc. The bar-coded tag of the present invention is essentially an up-dated version of this tag, which is coupled electronically into an extensive database of soldiers' information. In the event that a soldier (here the term “soldier” applies to service members in the Army, Navy, Marines, Air Force, Coast Guard, etc.) is injured in a combat zone, his/her tag would be scanned by the field scanner of the invention and a photo of the soldier taken. This information, along with physical health information (injured, uninjured, etc.) would then be uploaded to a database where it would have varying levels of accessibility, depending on the authorization level of the person inquiring about the soldier in question.

The description below uses as an example a system used by law enforcement. As described above, the system can be used for many different applications, including prison systems and military applications. In accordance with a criminal justice application of a preferred embodiment of the invention, a law enforcement authority provides tags with unique machine-readable identification information to law enforcement officers, typically prior to commencing law enforcement activities (i.e., “going on patrol”). If the officer during his patrol subsequently detains and arrests an individual (the “arrestee”), that officer will attach a tag to the arrestee (e.g., as a bar coded bracelet or anklet). After the tag is attached, the officer uses an electronic device, such as a mobile phone running a Data Input App, to record arrestee information, preferably including one or more images of the arrestee formed by the electronic device and the physical location, such as using GPS coordinates, where the arrestee was apprehended. Also information that identifies the device that scanned the tag and the device that took any photographs, as well as the time and location of each photograph, is recorded and uploaded. Other arrestee information can be recorded using an input device such as a keyboard or touch screen. Such information can include the name of the arrestee and any other information, such as the condition of the arrestee (deceased, injured, uninjured). The machine-readable information from the tag, along with the arrestee information, is stored in the machine and uploaded to a database, either immediately after scanning or, if no connection is available, the information is stored in the machine for uploading later.

When the arrestee is transported to a holding or interrogation facility, the tag is scanned again and the identity and location of the scan is uploaded to the event database. Every time the arrestee is transported over a significant distance (i.e., a distance detectable by GPS location-finding), the tag may be scanned again and uploaded to the event database, in some instances accompanied by a new photograph taken with the scanning device.

While is it desirable to include as much information as possible on the tag, the particular implementation will determine what information may be included. For example, if the tag is created by a central authority and provided to organizations, the tag might include neither the name of the person attaching the tag to a person nor the name of the person tagged, but preferably will include a unique identifying number and the organization to which the tag is issued. In some cases, the tag may include only the unique identifier. If the tag is created within an organization, it may also include the name of a specific person, such as a police officer, soldier, prison guard, or parole officer, to whom the tag is issued. If the tag is created near the scene where the arrestee was first detained, the tag could be created to include the name of the person tagged, if known, and the GPS coordinates of the location where the tagged person was initially detained. Information not available when the tag is created can be entered into the electronic device and uploaded with the tag information.

A preferred embodiment of the system includes a field hardware component capable of reading the machine-readable tag. For example, the field hardware could comprise a general purpose cell phone, portable computer, or tablet, or a device manufactured specifically for use with the invention. In some embodiments, the machine readable code may be a bar code, a QRS code, or a radio frequency identification (RFID) code embedded in a microchip, such as an RFID microchip complying with ISO 11784 or 11785. The tag includes a means for attaching the tag to an individual, such as a clip or a tie wrap that can be wrapped around a person's arm, leg, wrist, etc.

After the tag is attached, the person attaching the tag uses an electronic device, such as a mobile phone running an App, to scan the tag, reading the information on the tag, and uploading the information to a database. The information that is uploaded is a combination of information read from the tag and information determined independently of the tag. Some of the information determined independently of the tag may be information derived from the device, such as a device identifier or positional information, such as GPS coordinates, determined by the device. Some of the information can be one or more photographs captured by the device or information manually entered by the person attaching the tag. That is, the database preferably include four types of information: information read from the machine-readable tag, information generated by the reading device, information manually entered into the device by the user, and information attached to the database after upload. As much information as possible is included on the machine-readable tag, although information that is not available when the tag is printed can be entered manually after it becomes known. In some embodiments, the machine-readable tag can be scanned by a user before the tag is attached to a tagged person and information, such as the person who received the tag for attaching or the identification of a particular mission, can be stored in the device and associated with unique tag identifier. After the tag is attached and scanned, the information scanned from the tag, any information stored in the device in association with the tag, any photographs, as well as any additional information entered or generated by the device, is uploaded.

The software can upload, for example, the name of the entity to whom the tag was issued, the person attaching the tag to the arrestee, a photo of the arrestee, the arrestee's identity (if alive or verified) and the GPS location where the arrestee was first detained. After the tag is scanned, the device is activated to transmit the photo and information on the tag to an internet database that is maintained by the federal, state, or local government authority. Once uploaded, the uploaded information can be linked with other information, such as other information related to the tagged person or information related to the organization issuing the tag.

In some embodiments, police departments can use the invention to know where their patrolmen on the streets are at all times. Currently, police departments always know where the car is but not the officer. Now anytime the officer leaves the car, the software is activated to allow GPS tracking of the officer. If he gets injured and calls in (or even if he can't) the police department will be able to find him with GPS location.

In accordance with an embodiment of the invention, when the officer makes an arrest he or she immediately puts the tie-wrap with the barcode on the wrist of the detainee. Scan the barcode, take a photo and hit send. Now the police department knows the immediate GPS location of the arresting officer and the photo goes directly into a database and if the local, State & federal criminals and facial recognition matches that photo of the detainee to photos in their database, the police department immediately knows if the person has been previously arrested or in jail. The city immediately knows of prior arrests or if there is a warrant for the detainees arrest. Plus the dispatching officer knows the immediate location of the officer and detainee. When the arrested person arrives for processing, the detainee will be rescanned. This places the date, time, and GPS location of the detainee upon arrival showing he or she has arrived at the jail.

Local, state & federal agencies can use the software and hardware of the present invention to enhance the safety of their officers, as well documenting detainees for their safety and to protect the agency from false accusations.

Use of the Database

In some embodiments, portions of the database can be made available to the public to provide friends and family members the ability to easily verify the condition of an arrestee, prisoner, POW, or soldier. If a person has a friend or loved one who may have been arrested or injured in combat, they can go to the website URL provided by a government agency, and enter the name of the person they're searching for. If the person has been tagged, their name will be on the list, along with the status of the person, that is, deceased, hospitalized, or released, and where detained. If the person is in a hospital, the name and GPS location of the hospital can be available along with the person's name. Now their loved ones can immediately know they are alive and/or being treated at that facility.

In some embodiments, to protect the privacy of victims or prisoners, or the security of law enforcement or correctional officers or military personnel, the database may be only available to certain authorized individuals, and friends or family would need to contact an official to search the database. In some embodiments, an official can provide a password that allows a family or friend to search the database for a specified individual or individuals. The password can control the information that is available to the searcher. For example, specific information or photographs that might be upsetting to a family might not be made available.

In some embodiments, family or friends of an individual who has been arrested or injured in a combat zone can download one or more images of the person of interest. The downloaded image can be matched to photographs uploaded by emergency workers, either using image recognition software or manually, thus verifying true identity.

Various embodiments of the invention provide advantages over current methods.

Embodiments allow people to quickly and easily find the status of a loved one by logging into a federal, state, or local government, or non-governmental agency website and enter the name of their friend or loved ones and instantly know their current location, if they've escaped injury or are being treated in a hospital.

Embodiments allow law enforcement officers or military personnel to use existing cell service or if there is no cell service, satellite communications.

Accurate reporting of arrestees, parolees, POWs, and soldiers in combat zones provides many advantages. Many people can be relieved of hours, days, weeks or months of mental anguish if they can determine the location and condition of their family members or loved ones, even in cases where that person has been arrested and entered the legal system, or is a POW or injured soldier.

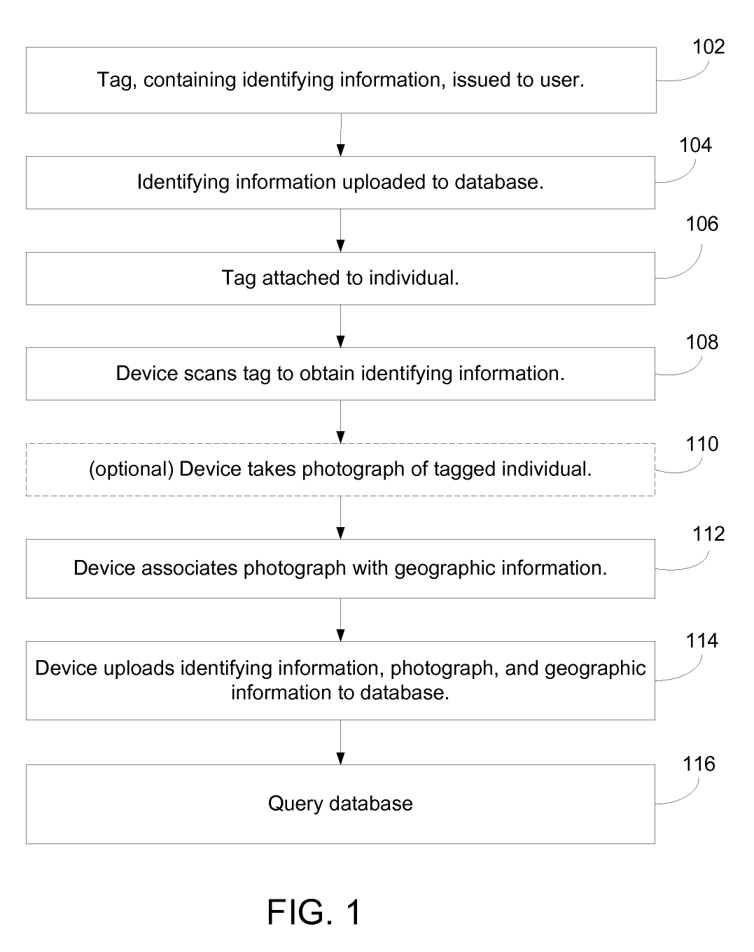

As described above and in FIGS. 1-3 below, embodiments of the invention typically involve a system “user” who is issued identification tags, and a “tagged individual” who is subsequently tagged by the “user.” In the following description, the terms “user” and “tagged individual” have the following meanings:

1) Law Enforcement—in this application of the invention, the “user” would typically be a law enforcement officer, such as an FBI agent, BATF agent, police officer, state trooper, etc. The “tagged individual” would be someone who has just been arrested by the “user”, and who may be termed the “arrestee”. No implication of guilt or innocence is implied at the time of tagging by the user, and the tagging process can be viewed by the arrestee as a form of protection against later physical abuse within the law enforcement system since the photograph taken at time of arrest serves as visual documentation of the arrestee's initial physical condition at time of arrest. Conversely, the arresting officer is also protected by the invention since false charges of police brutality may be debunked by reference to the photographs taken at time of arrest.

2.A) Correctional System (after release from jail or prison)—in this application of the invention, the “user” would be a parole officer or other person responsible for the monitoring of parolees as they reintegrate into society following release from incarceration. The tagged individual” would be a parolee.

2.B) Correctional System (jail or prison)—in this application of the invention, the “user” would be an admitting officer to the confinement facility (prison, jail, holding “tank”, etc.) or other officials within that facility. The “tagged individual” would be a prisoner.

3) Prisoner of War (POW)—in this application of the invention, the “user” would be a soldier within a combat zone who has just detained (or killed) a terrorist or enemy combatant. The “tagged individual” would be the terrorist or POW just captured or killed by the “user”.

4) Soldiers in a Combat Zone—in this application of the invention, the “user” would be a soldier who has just encountered an injured fellow soldier and has placed the computer-readable tag on that fellow soldier's wrist, arm, leg, etc. The “tagged individual” would be the injured fellow soldier.

In the figures and claims below, the terms “user” and “tagged individual” should be interpreted with the above definitions, depending on the specific context in which the present invention is applied. The invention is not limited to the examples provided above.

FIG. 1 shows one embodiment of the method of enumerating and tracking people (“tagged individuals”) by a user according to the invention. As discussed above, the “user” may be a law enforcement officer, prison official, parole officer, or soldier, depending on the specific application of the invention. The “tagged individual” may be a captured enemy combatant or POW, a prisoner, a parolee, or an injured soldier, also depending on the specific application.

In step 102, a tag, containing identifying information is issued to a user. The tag can be issued, for example, by a governmental agency or the military. The term “tag” includes any machine-readable encoded information, such as a physical tag with a printed bar code or QRS code, as well as a code embedded in circuitry, such as an RFID circuit. In step 104, after the tag is issued, the identifying information corresponding to the tag is uploaded to one or more databases.

The context for tagging an individual in step 106 depends on the specific application of the invention. In a law-enforcement situation (#1 above), an individual would be tagged by the user when that individual is being detained (arrested) by the user. In a correctional system situation (#2.A and #2.B), the user would tag the individual upon entry to the parole system, or when first entering prison or jail. In a combat zone (#3), the user would tag the individual when that individual is first captured in the combat zone. In this context, “captured” may also include “killed” during combat. In either situation, visual and locational (GPS) documentation of the status of killed or captured enemy combatants serves several useful purposes as described above. Finally, also in a combat zone (#4), when a soldier encounters an injured fellow soldier, the user would tag the injured individual.

In step 108, an electronic device, such as a smart phone, scans the tag to obtain the identifying information. In optional step 110, the device or smartphone also takes a photograph of the tagged individual, and in step 112, the device associates the photograph with geographic information specific to the location where the individual was tagged. Depending on the application, the tagging initial location may be: 1) where the tagged individual was arrested, 2.A) where a parolee was located when first entering the parole system (possibly the releasing area of a prison or jail), 2.B) where a prisoner first was inducted into the prison (or jail) population, 3) where an enemy combatant was captured or killed, or 4) where a fellow soldier was injured. Note that as the tagged individual is transported to new locations, the location data in the database will preferably continue to track the current location of the tagged individual (based on GPS). Thus, in case 1) the current location would track the arrestee through the justice system; in case 2.A) the current location would track the parolee, thereby enabling enforcement of location restrictions (in child abuse and sex offender cases, for example); in case 2.B) the current location would track an incarcerated prisoner; in case 3) the current location would track the movement of a captured POW away from the combat zone to a better location for interrogation and confinement; and in case 4) the current location would track the movement of an injured fellow soldier to hospital facilities.

In step 114, once the device or smartphone has obtained these pieces of information, the device uploads the identifying information, photograph, geographic information, and any other information entered by the user to the database. The database or website used to store the information can also be accessed for inquiries regarding tagged individuals and their geographic locations.

In step 116, the database is queried and information is supplied to a requester. Access to the database can be password controlled or some database information can be available without password. The identifying information, photograph, and geographic information can be uploaded together or separately as well as at the same time or at different times. The information upload can be performed by any electronic means, which can include though a global computer network, though a satellite communication network, or through a telephone network. The database can be a computer-readable database containing information in electronic form which includes the images of the tagged individuals, geographical information describing both the initial (where tagged) and current positions of the tagged individual, and identifying information (if available) of the user to whom the tag was issued. The database can also compile the information in the database of tagged individuals in a specific geographic region into a summary.

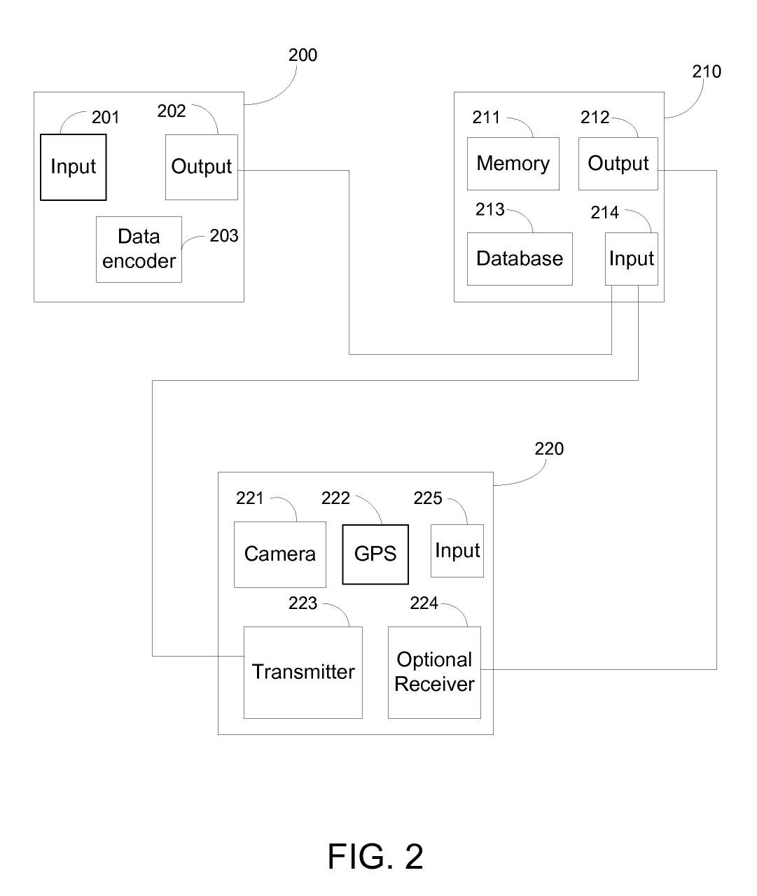

FIG. 2 depicts a several devices connected through a network according to one embodiment of the present invention. An issuing device 200, a database computer 210, and a field use device 220 are connected over a network (not shown). The network is an example of one of the possible electronic means for transferring information from the devices 200, 220 to the computer 210 and vice versa. The issuing device 200 includes an input 201, an output 202 to link to the database computer 210, and a data encoder 203 for encoding identification data into, for example, a bar code, a QRS code, or an RFID. The computer 210 includes an input 214 and output 212 for linking to the issuing device 200 and field use device 220, respectively. The computer also has memory 211 for storing information uploaded from the issuing device 200 or the field use device 220 and a database 213 for accessing the information through a user interface, such as a website. The field use device 220 contains a camera 221 for taking photographs of the tagged individual, a GPS 222 receiver for acquiring geographic coordinates to associate with the photographs, an input 225 for retrieving identifying information from, for example, bar codes, QRS codes, or RFIDs, a transmitter 223 for uploading the identifying information, photograph, and geographic coordinates to the computer 210, and an optional receiver 224 for confirming that the upload has been performed to the computer 210.

The field use device 220 can be a smartphone or some other electronic apparatus. A computer system, such as a website, can be programmed to receive first information regarding the issuance of a tag, which includes encoded machine readable identification information, permitting a user to store the first information in a database, to receive electronically from the user whom the tag was issued, second information including an image of the tagged individual, geographical information describing the position of the tagged individual, and identifying information of the user to whom the tag was issued, to decode the machine-readable identification information, to store in the database the second information, to associate in first information with the second information using the decoded identification information, and to output upon request a confirmation.

A multitude of field use devices 220 can send information to, and/or receive information from, the computer 210 simultaneously or at different times. Each field use device 220 can separately communicate with the website and/or database computer 210 to upload information, for example, of tagged individuals in various locations. A multitude of issuing devices 200 can also send information to the computer 210 simultaneously or at different times.

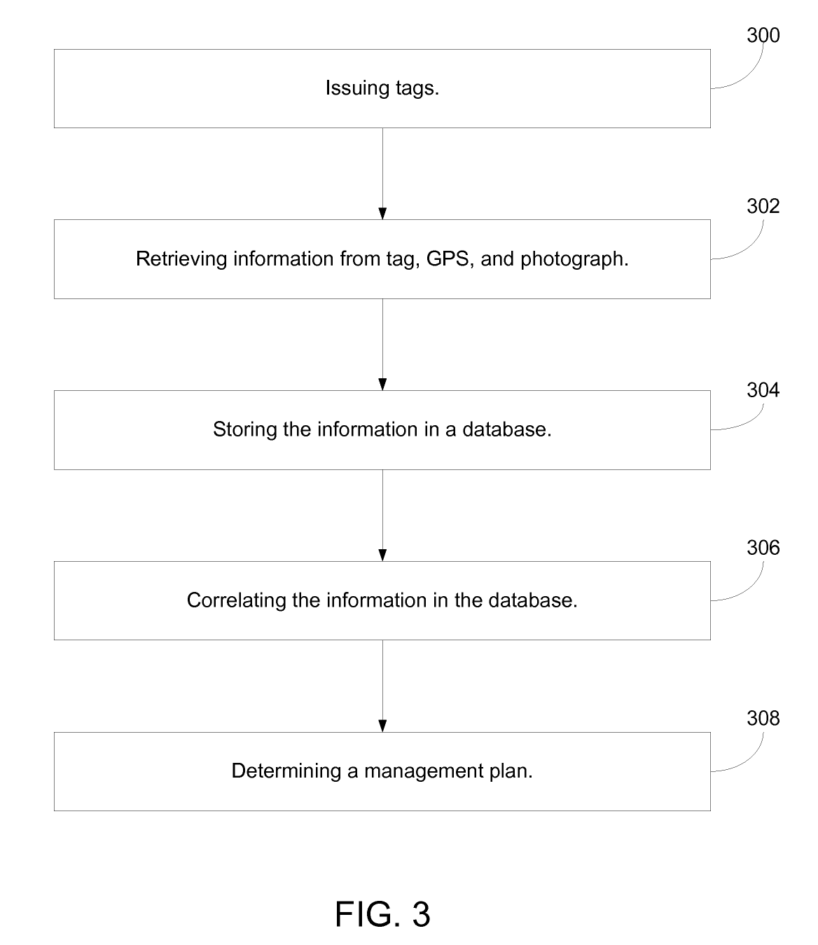

FIG. 3 shows a method of tracking tagged individuals according to an embodiment of the present invention. In step 300, a tag, which contains machine-readable coded information identifying the user to whom the tag is issued, is given to the user. Information concerning the issuance of the tag is uploaded to a database. In step 302, information is obtained from the tag, which is attached to a tagged individual, and a photograph of the tagged individual and GPS coordinates are acquired. The GPS coordinates are associated with the photograph. In step 304, the tag information, photograph, and GPS coordinates are stored in the database. In step 306, the related information in the database is correlated. In step 308, a management plan of the information in the database is determined. This plan governs the way the information is stored and displayed to users accessing the database for information. The database may be used for additional purposes during such as: 1) determining which geographical areas and structures have already been covered and which areas and structures have not been covered yet (this information would be derived from the overall set of GPS locations of tagged individuals—areas which possibly have not yet been covered would be conspicuous from the lack of any GPS coordinates within those areas), 2) allocation of users on a real-time basis to reduce the average time to tag individuals, 3) optimizing future procedures and patterns, and 4) documentation of the performance of the users in tagging individuals, to determine successes and failures, and determine any training requirements for these users.

A preferred method or apparatus of the present invention has many novel aspects, and because the invention can be embodied indifferent methods or apparatuses for different purposes, not every aspect need be present in every embodiment. Moreover, many of the aspects of the described embodiments may be separately patentable. The invention has broad applicability and can provide many benefits as described and shown in the examples above. The embodiments will vary greatly depending upon the specific application, and not every embodiment will provide all of the benefits and meet all of the objectives that are achievable by the invention. The term “bar-coded bracelet” may also include microchips or other types of computer-readable labeling media.

It should be recognized that embodiments of the present invention can be implemented via computer hardware, a combination of both hardware and software, or by computer instructions stored in a non-transitory computer-readable memory. The methods can be implemented in computer programs using standard programming techniques—including a non-transitory computer-readable storage medium configured with a computer program, where the storage medium so configured causes a computer to operate in a specific and predefined manner—according to the methods and figures described in this Specification. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits programmed for that purpose.

Further, methodologies may be implemented in any type of computing platform, including but not limited to, personal computers, mini-computers, main-frames, workstations, networked or distributed computing environments. Aspects of the present invention may be implemented in machine readable code stored on a non-transitory storage medium or device, whether removable or integral to the computing platform, such as a hard disc, optical read and/or write storage mediums, RAM, ROM, and the like, so that it is readable by a programmable computer, for configuring and operating the computer when the storage media or device is read by the computer to perform the procedures described herein. Moreover, machine-readable code, or portions thereof, may be transmitted over a wired or wireless network. The invention described herein includes these and other various types of non-transitory computer-readable storage media when such media contain instructions or programs for implementing the steps described above in conjunction with a microprocessor or other data processor. The invention also includes the computer itself when programmed according to the methods and techniques described herein.

Computer programs can be applied to input data to perform the functions described herein and thereby transform the input data to generate output data. The output information is applied to one or more output devices such as a display monitor.

In the following discussion and in the claims, the terms “including” and “comprising” are used in an open-ended fashion, and thus should be interpreted to mean “including, but not limited to . . . . ” To the extent that any term is not specially defined in this specification, the intent is that the term is to be given its plain and ordinary meaning. The accompanying drawings are intended to aid in understanding the present invention and, unless otherwise indicated, are not drawn to scale.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method of tracking individuals, comprising:
issuing to an entity a tag including machine-readable coded information identifying the entity to which the tag is issued;
uploading information about the issuance of the tag to a database;
attaching the tag to an individual;
photographing the individual with the tag attached;
obtaining information for the initial location of the individual;
associating the photograph with the location information;
uploading the photograph, the location information, and identifying information to a database, that database providing information regarding individuals and their geographic locations; and
storing in a computer readable database the information an image of the individual, geographical information describing the initial current location of the individual when tagged and identifying information of the person to whom the tag was issued.

2. A system for tracking individuals, comprising:
receiving by an entity a tag to be attached to an individual, the tag including a machine-readable unique identifier, the unique identifier and user information being stored in a database;
attaching the tag to the individual;
scanning the tag with a device capable or reading the machine-readable unique identifier;
causing the machine-readable unique identifier from the tag and additional information not recorded on the tag to be uploaded to the database to be associated with the user information.

3. The system of claim 2 in which causing the machine-readable unique identifier from the tag and additional information not recorded on the tag to be uploaded to the database includes causing information generated by the device to be uploaded.

4. The system of claim 3 in which information generated by the device includes location information and/or device identification information.

5. The system of claim 2 further comprising photographing the individual and in which causing the machine-readable unique identifier from the tag and additional information not recorded on the tag to be uploaded to the database includes causing the photograph to be uploaded.

6. The system of claim 2 further comprising manually entering information regarding the individual and in which causing the machine-readable unique identifier from the tag and additional information not recorded on the tag to be uploaded to the database includes causing the manually entered information to be uploaded.

7. The system of claim 6 in which causing the manually entered information to be uploaded includes causing information about the sex and/or the age of the individual.

8. A system for tracking individuals, comprising:
issuing to an entity a tag to be attached to an individual, the tag including a machine-readable unique identifier, the unique identifier and entity information being stored in a database;
receiving uploaded information after the tag is attached to the individual, the uploaded information being obtained from a scan of tag with a device capable of reading the tag and the uploaded information including the unique identifier;
receiving additional uploaded information not recorded on the tag; and
associating the uploaded information and the additional uploaded information with the user.

9. The system of claim 8 in which receiving additional uploaded information includes receiving information generated by the device.

10. The system of claim 9 in which information generated by the device includes location information and/or device identification information.

11. The system of claim 8 in which receiving additional uploaded information includes receiving one or more photographs of the individual.

12. The system of claim 8 in which receiving additional uploaded information includes receiving additional information manually entered into the device.

13. The system of claim 12 in which receiving information manually entered into the device includes receiving information about the sex and/or the age of the individual.

14. The method of claim 8 further comprising compiling from the database summary information of individuals in a geographic region.

15. The method of claim 8 further comprising accessing the database by someone other than the person to whom the tag was issued to confirm that the information concerning the individual was uploaded to the data base.

16. The method of claim 8 in which the machine-readable unique identifier is encoded in a bar code or a QRS code.

17. The method of any of the above claims in which receiving uploaded information includes receiving the information through a global computer network, through a telephone network.

18. A computer system including a computer memory storing computer readable instructions to:
receive first information regarding the issuance of a tag intended for labeling an individual, the tag including encoded machine readable identification information;
store the first information in a database;
receive electronically from the person to whom the tag was issued second information including an image of the individual, geographical information describing the position of the individual, and identifying information of the person to whom the tag was issued;
decode the machine-readable identification information;
store in the database the second information;
associate the first information with the second information using the decoded identification information; and
output upon request information stored in the database.

19. The computer system of claim 18, wherein the output of information from the database is restricted to a subset of the information stored in the database.

20. The computer system of claim 18, wherein the output of information from the database is restricted to certain persons, such as family members and loved ones of individuals.
